(19) United States
(12) Patent Application Publication
(10) Pub. No.: US 2010/0242873 A1
(43) Pub. Date: Sep. 30, 2010

(54) Valve drive arrangement

(76) Inventors: Jens Meintschel, Bernsdorf (DE); Thomas Stolk, Kirchheim (DE); Alexander Von Gaisberg-Helfenberg, Beilstein (DE)

Correspondence Address: KLAUS J. BACH, 4407 TWIN OAKS DRIVE, MURRYSVILLE, PA, 15668, US

(21) Appl. No.: 12/800,478

(22) Filed: May 14, 2010

Related U.S. Application Data
(63) Continuation-in-part of application No. PCT/EP2008/008843, filed on Oct. 18, 2008.

(30) Foreign Application Priority Data
Nov. 17, 2007 (DE) 10 2007 054 979.4

(51) Int. Cl. F01L 1/00; G01M 13/00

(52) U.S. Cl. 123/90.1; 73/114.79

(57) ABSTRACT

In a valve drive arrangement for an internal combustion engine, with a camshaft including at least one cam element which is axially movable by means of a switching gate structure for adjusting the valve drive, and a sensor unit for determining an axial control position of the cam element, the sensor unit has at least a first sensor element coupled to an axial movement of the cam element whose operation position can be determined by a corresponding sensor element.

This is a Continuation-In-Part Application of pending international patent application PCT/EP2008/008843 filed Oct. 18, 2008 and claiming the priority of German patent application 10 2007 054 979.4 filed Nov. 17, 2007.

### BACKGROUND OF THE INVENTION

The invention relates to a valve drive arrangement for an internal combustion engine including a camshaft with a cam element which is axially movable supported on the camshaft for changing the operation of the respective valve.

Valve drive arrangements, especially for an internal combustion engine, with at least one cam element that can be axially moved by means of a switching gate, which is provided for realizing an adjustable valve drive, and with a sensor unit that is provided to determine an axial switching position of the cam element, are already known.

It is especially an object of the present invention to increase the reliability of a determination of the switching position of the cam element.

### SUMMARY OF THE INVENTION

In a valve drive arrangement for an internal combustion engine, with a camshaft including at least one cam element which is axially movable by means of a switching gate structure for adjusting the valve drive, and a sensor unit for determining an axial control position of the cam element, the sensor unit has at least a first sensor element coupled to an axial movement of the cam element whose operation position can be determined by a corresponding sensor element.

“Axial” refers to a rotational axis of the cam element here and in the following description. The sensor unit provides a signal that can be evaluated by a calculation unit so that the calculation unit can define the switching state. The switching position of the cam element can be determined directly by an arrangement according to the invention, whereby the reliability of the determination of the switching position in particular is increased. A passive first sensor element is thereby preferably connected to the cam element and is sensed by a corresponding active sensor element, which is arranged in a stationary manner.

It is further suggested that the sensor unit is designed so as to be contact-free. A particularly low-wear sensor unit can be realized thereby. An inductive method is here especially advantageous.

It is further suggested that the sensor unit has at least one second sensor element coupled at least in part to a rotational movement of the cam element, by means of which a phase position can be determined by a corresponding sensor element. The sensor unit can thereby be expanded in a reasonable manner.

The second sensor element is preferably in the form of a sensor wheel. The phase position can be determined in a particularly simple manner by means of a sensor wheel. However, other second sensor elements for determining the phase position which appear to be sensible to the expert, are also conceivable. The corresponding sensor element is thereby preferably designed as an active sensor element and formed in one piece with the active sensor element for determining the axial switching position. An additional active sensor element is thereby not needed, whereby construction costs can be reduced in particular.

It is further suggested that the first sensor element is provided to define a topology. A topology is meant to refer to the form of a surface. A definable signal can be generated by such an arrangement in a simple manner, in particular by an inductive measuring method. Alternatively, a material property can also be changed, whereby a sensor element that can easily be sensed also can be switched.

The topology may be associated with a switching position in a defined manner. The switching position can thereby be determined in a particularly simple manner.

In a particular embodiment of the invention the first sensor element and the second sensor element are formed at least to some extent as a single piece. A particularly advantageous arrangement of a valve drive device according to the invention is thereby possible. The sensor wheel is preferably formed in the shape of a gear wheel, wherein the sensor element is in the form of a filled gap between two teeth. It is however alternatively also possible to provide the sensor element in the form of an omission of a tooth of the sensor wheel.

The valve drive thereby preferably has at least two axial sections, which are provided to define the switching positions. One can distinguish between the different switching positions of the cam element in a simple manner by means of axial sections, especially by axial sections of the cam element with a different topology. The one sensor element, preferably the active sensor element is thereby preferably arranged in a stationary manner, and detects the one axial section in the one switching position, and the other axial section in the other switching position.

It is suggested thereby that the first sensor element is arranged completely in one of the sections. The topology of the corresponding section can thereby be defined in a particularly simple manner. A different geometry of the sections can thereby be achieved in particular. A circumferential groove with a planar topology is preferably arranged between the axial sections of the sensor wheel, whereby the sections of the sensor wheel can be separated in a better manner. A multi-part embodiment of the sensor wheel is thereby especially advantageous, wherein the parts of the sensor wheel are preferably spaced, so that a circumferential groove between the parts of the sensor wheel is formed.

In a further embodiment of the invention the valve drive device has a switching device, which is provided to switch the first sensor element. By means of a switchable sensor element, a switching position can also easily be determined, in particular if the sensor element is switched in dependence on the operating position of the cam element.

The switching device is thereby advantageously provided to change the topology in dependence on the axial switching position of the cam element by means of the first sensor element. Thereby, a change can easily be sensed by the sensor unit, by means of which the switching position can be determined.

The invention will become more readily apparent from the following description of particular embodiments thereof on the basis of the accompanying drawings.

### BRIEF DESCRIPTION OF THE DRAWINGS

FIG. 1 shows a valve drive arrangement with a first embodiment of a sensor unit,

FIG. 2 shows a sensor element of the valve drive device of FIG. 1,

FIG. 3 shows a further view of the sensor element,

FIG. 4 shows a valve drive device with a second embodiment of a sensor unit,

FIG. 5 shows the sensor unit of FIG. 4 in a cross section,

FIG. 6 shows a valve drive device with a third embodiment of a sensor unit and

FIG. 7 shows the sensor unit of FIG. 6 in a cross section.

### DETAILED DESCRIPTION OF A Ptr Embodiment

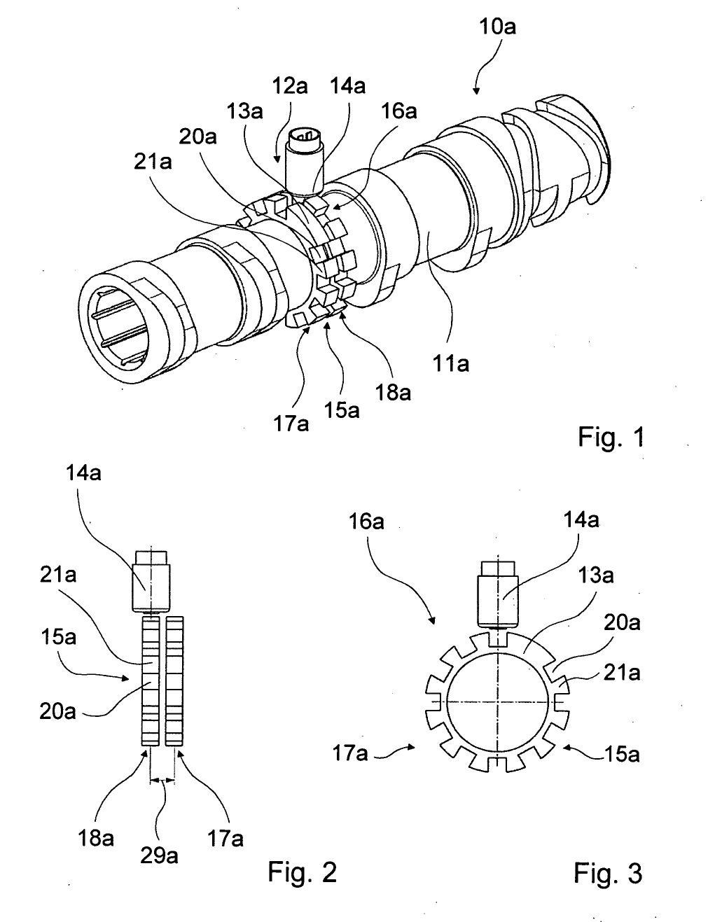

FIG. 1 shows a valve drive arrangement of an internal combustion engine with a cam element 11a that can be moved axially by means of a switching gate structure 10a, which cam element is arranged on a camshaft, not shown in detail here, and by means of which a switchable valve drive can be provided of gas exchange valves of the internal combustion engine, not shown in detail. A second cam element, which can also be moved via the switching gate structure 10a, is not shown in detail here.

The valve drive device has a sensor unit 12a, by means of which an axial switching position of the cam element 11a can be determined.

The axial switching position of the cam element 11a is determined by means of a first sensor element 13a of the sensor unit 12a, which is coupled to an axial movement of the cam element 11a. A corresponding sensor element 14a, which is designed as an active sensor element 14a, is arranged in a stationary manner. The sensor unit 12a is thereby in the form of a contact-free sensor arrangement.

The sensor unit 12a can further determine a phase position of the cam element 11a by means of the same active sensor element 14a and a second sensor element 15a, that senses a rotational movement of the cam element 11a. The second sensor element 15a is formed as a sensor wheel for this, which is connected to the cam element 11a in a torque-proof manner. It has two axial sections 17a, 18a. A mean distance 29a between the sections 17a, 18a of the second sensor element 15a corresponds to an axial switching length of the cam element 11a (FIG. 2).

Both parts of the second sensor element 15a in the form of a sensor wheel have a gear wheel-like structure, by which current pulses are induced in the active sensor element 14a, for determining the phase position of the cam element 11a. One of the tooth gaps 20a between the teeth 21a of the second sensor element 15a formed as a sensor wheel is filled out and forms the first sensor element 13a with the first section of the second sensor element 15a. The first sensor element 13a is thereby designed in one piece with the second sensor element 15a and thus defines a topology 16a sensed by the active sensor element 14a. Each section 17a, 18a can thereby be associated with a switching position of the cam element 11a in a defined manner. The first section 17a of the second sensor element 15a has an irregularity due to the first sensor element 13a, which is used for determining the switching position of the cam element 11a. The second section 18a of the second sensor element 15a has tooth gaps 20a and teeth 21a arranged circumferentially in a regular manner.

If the cam element 11a is in a first switching position, a signal course of the active sensor element 14a has an enlarged distance with a constant rotational speed between two signals than between the other signals. If the cam element 11a is in a second switching position, the signal course of the active sensor element 14a is regular with the same distances between all signals. The switching position and the phase position of the cam element 11a can thereby be determined by means of the sensor unit 12a.

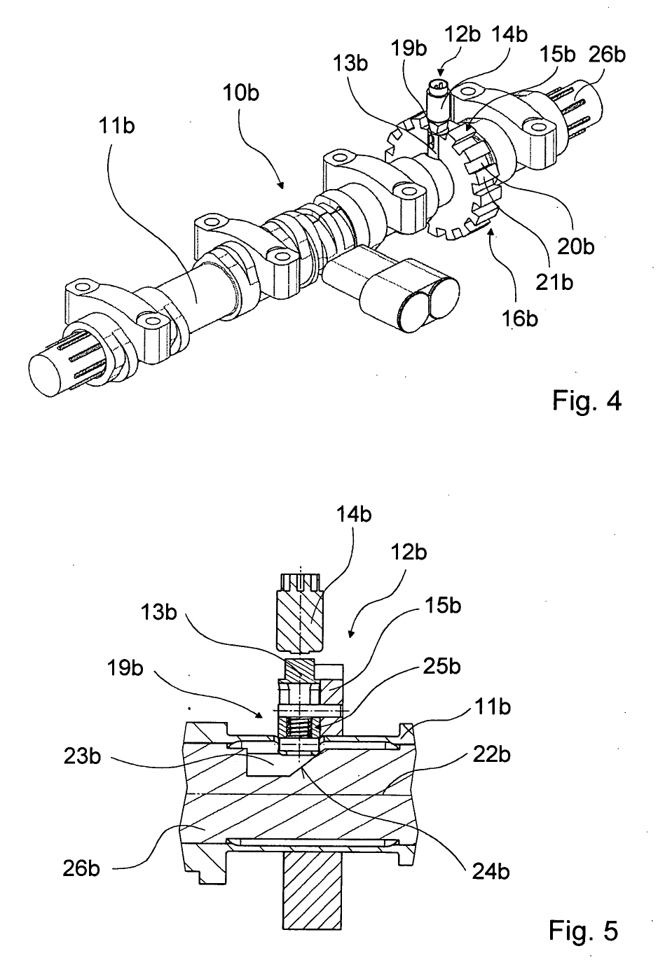

FIGS. 4 and 5 show a further arrangement of a valve drive device with a sensor unit 12b. For distinguishing the embodiments, the letter a in the reference numerals of the embodiment in FIGS. 1 and 3 is replaced by the letters b and c in the reference numerals of the embodiments in FIGS. 4 to 7. The following description is essentially restricted to the differences to the embodiment of FIGS. 1 and 3, wherein reference is made to the description of the embodiment in FIGS. 1 and 3 with regard to the same components, characteristics and functions.

The embodiment of FIGS. 4 and 5 has a second sensor element 15b, which has an axial width of at least the same size as an axial switching path of a cam element 11b. The second sensor element 15b is formed as a sensor wheel and has a gear wheel-type structure. One of the teeth 21b of the second sensor element 15b is thereby formed as a first sensor element 13b. A topology of the second sensor element 15b can be switched by means of the first sensor element 13b.

In a first switching position of the cam element 11b, the first sensor element 13b is retracted and has a radial height, which approximately corresponds to a basic circle level of the second sensor element 15b that is a sensor wheel (FIG. 4). In a second switching position of the cam element 11b, the first sensor element 13b is extended and has a radial height which is in particular larger than the radial height in the first switching position of the cam element 11b and which essentially corresponds to a radial height of the remaining teeth 21b of the second sensor element 15b (FIG. 5). A “radial height” is thereby especially meant to be a radial distance of a surface of the first sensor element 13b proceeding in the circumferential direction from a rotational axis 22b of the cam element 11b.

In order to change a topology 16b of the second sensor element 15b in dependence on an axial switching position of the cam element 11b, the sensor unit 12b has a switching device 19b, by means of which the radial height of a first sensor element 13b can be changed.

The switching device 19b has a recess 23b formed into the camshaft 26b. The recess 23b has a radially outwardly extending chamfer 24b at one end. In the first switching position of the cam element 11b, the first sensor element 13b is retracted into the recess 23b. A spring unit 25b with a spiral spring exerts a radially inwardly directed force on the first sensor element 13b. In the second switching position of the cam element 11b, the first sensor element 13b is pressed radially outwardly via the chamfer 24b. The first sensor element 13b, the second sensor element 15b and the cam element 11b are connected to each other rigidly for axial movement.

A phase position of the cam element 11b can thus be determined easily by means of the rigidly arranged teeth 21b of the second sensor element 15b. The switching position of the cam element 11b can be determined by means of the signal course, which depends on the switching position of the first sensor element 13b.

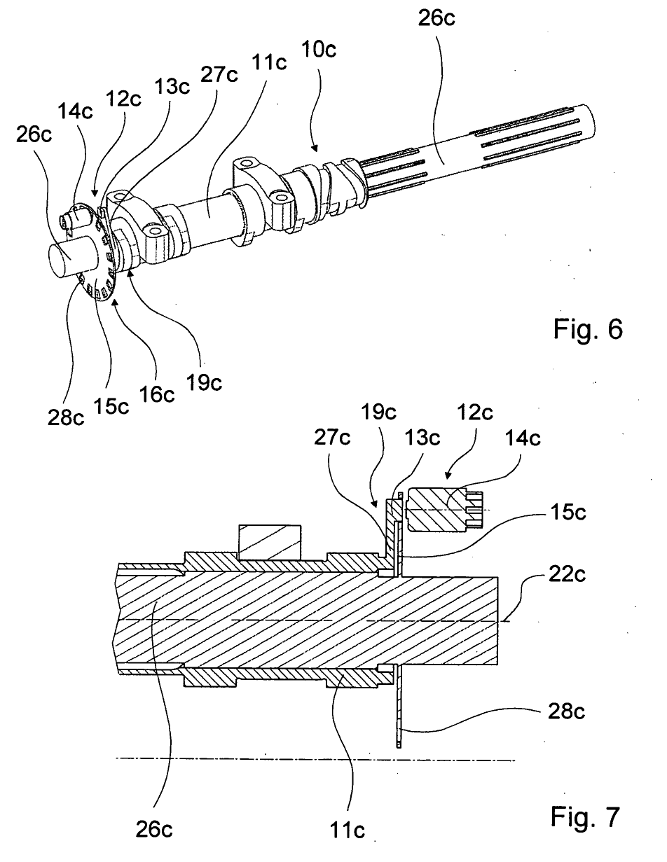

A further embodiment of a valve drive device with a sensor unit 12c, which has a second sensor element 15c formed as a sensor wheel with a changeable topology 16c, is shown in FIGS. 6 and 7.

In this embodiment, the second sensor element 15c is rigidly connected to a cam shaft 26c of the valve drive device. The second sensor element 15c is designed as a perforated disk, wherein a main extension plane of the second sensor element 15c extends perpendicularly to a rotational axis 22c of a cam element 11c or the camshaft 26c. An active sensor element 14c which determines a phase position of the cam element 11c by means of the second sensor element 15c is arranged parallel to the rotational axis 22c.

The sensor unit 12c further has a first sensor element 13c, which is connected in a fixed manner to the cam element via a holding device 27c and which forms a switching device 19c therewith. The first sensor element 13c is arranged on a side of the second sensor element 15c facing away from the active sensor element 14c and has a size which corresponds to a size of a corresponding opening 28c of the second sensor element formed as a perforated disk.

In a first switching position, the first sensor element 13c is outside the openings 28c of the second sensor element 15c, whereby the active sensor element 14c detects all openings 28c. In a second switching position of the cam element 11c, the first sensor element 13c fills out one of the openings 28c of the second sensor element 15c, whereby a signal of the active sensor element 14c changes. Due to the signal of the active sensor element 14c, the phase position and the switching position of the cam element 11c can be determined.

What is claimed is:

1. A valve drive arrangement, for an internal combustion engine, with a camshaft having at least one cam element (11a; 11b; 11c) which is axially movably supported on the camshaft, a switching gate structure (10a; 10b; 10c) for axially adjusting the position of the cam element, and a sensor unit (12a; 12b; 12c) for determining an axial operating position of the cam element (11a; 11b; 11c), said sensor unit (12a; 12b; 12c) having at least a first sensor element (13a; 13b; 13c) which is at least partly coupled to the axial movement of the cam element (11a; 11b; 11c), for detecting the momentary operating position of the cam element with the help of a corresponding sensor element (14a; 14b; 14c).

2. The valve drive arrangement according to claim 1, wherein the sensor unit (12a; 12b; 12c) is a contact-free sensor device.

3. The valve drive arrangement according to claim 1, wherein the sensor unit (12a; 12b; 12c) includes a second sensor element (15a; 15b; 15c) which is at least partly coupled to a rotational movement of the cam element (11a; 11b; 11c), by means of which sensor element a phase position can be determined by a corresponding sensor element (13a; 13b; 13c).

4. The valve drive arrangement device according to claim 3, wherein the second sensor element (15a; 15b, 15c) is in the form of as a sensor wheel.

5. The valve drive arrangement according to claim 1, wherein the first sensor element (13a; 13b; 13c) is provided to define a topology (16a; 16b; 16c), which is indicative of an operating position of the cam element.

6. The valve drive arrangement according to at least claim 3, wherein the first sensor element (13a; 13b; 13c) and the second sensor element (15a; 15b; 15c) are designed at least partly in one piece.

7. The valve drive arrangement according to claim 6, wherein the sensor element (15a) has at least two axial sections (17a, 18a), which are provided to define the switching positions.

8. The valve drive arrangement according to claim 7, wherein the first sensor element (13a) is arranged completely within one of the axial sections (17a, 18a).

9. The valve drive arrangement according to claim 1, wherein a switching device (19b; 19c), is provided for switching the first sensor element (13b; 13c).

10. The valve drive arrangement according to claim 5, wherein the switching device (19b; 19c) is provided to change the topology (16b; 16c) in dependence on the axial switching position of the cam element (11b; 11c) by means of the first sensor element (13b; 13c).

11. A method of determining the operating position of a cam element of a valve drive arrangement, of an internal combustion engine, which cam element (11a; 11b; 11c) is axially movable by means of a switching gate (10a; 10b; 10c), which is provided to realize an adjustable valve drive, and with a sensor unit (12a; 12b; 12c) which is used for determining an axial operating position of the cam element (11a; 11b; 11c), said method comprising the steps of the operating position by means of at least one sensor element (13a; 13b; 13c) which is coupled at least partly to an axial movement of the cam element (11a; 11b; 11c).
